(19) United States
(12) Patent Application Publication
(10) Pub. No.: US 2004/0047497 A1
(43) Pub. Date: Mar. 11, 2004

(54) User interface for viewing medical images

(75) Inventors: Shawni Daw, Redmond, WA (US); Chris H. Wood, North Bend, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Confirma, Inc., Kirkland, WA (US)

(21) Appl. No.: 10/238,298

(22) Filed: Sep. 10, 2002

(51) Int. Cl. G06K 9/00

(52) U.S. Cl. 382/128

(57) ABSTRACT

A user interface is used to view images, such as medical images. The images are organized according to slices, which may be spatially related to one another, and according to series having slices aligned with corresponding slices in other series. The series may be temporally related to each other. A user input device, such as a mouse, is provided. Clicking on a button of the mouse and dragging up/down results in display of slices within a particular series. Clicking on the button of the mouse and dragging left/right results in display of aligned slices from different series.

### BACKGROUND OF THE INVENTION

1. Field of the Invention

This disclosure generally relates to improved techniques to visually display images, and in particular but not exclusively, relates to an apparatus and method for providing an improved user interface for use by medical personnel in reviewing medical images.

2. Description of the Related Art

The collection and storage of a large number of medical images is currently carried out by a number of systems. The medical images can be collected by a variety of techniques, such as nuclear magnetic resonance (NMR), magnetic resonance imaging (MRI), computed tomography (CT), ultrasound, and x-rays. One system for collecting a large number of medical images of a human body is disclosed U.S. Pat. Nos. 5,311,131 and 5,818,231 to Smith. These patents describe an MRI apparatus and method for collecting a large number of medical images in various data sets. The data are organized and manipulated in order to provide visual images to be read by medical personnel to perform a diagnosis.

One of the problems in reading a large number of images is for the medical personnel to understand the relationship of the images to each other while performing the reading. Another difficult task is interpreting the medical significance of various features that are shown in the individual images. Being able to correlate the images with respect to each other is extremely important in deriving the most accurate medical diagnosis from the images and in setting forth a standard of treatment for the respective patient. Unfortunately, such a coordination of multiple images with respect to each other is extremely difficult and even highly trained medical personnel, such as experienced radiologists, have extreme difficulty in consistently and properly interpreting a series of medical images so that a treatment regime can be instituted that best fits the patient's current medical condition.

Another problem encountered by medical personnel today is the large amount of data and numerous images that are obtained from current medical imaging devices. The number of images collected in a standard scan is usually in excess of 100 and very frequently numbers in the many hundreds. In order for medical personnel to properly review each image takes a great deal of time, and with the many images that current medical technology provides, a great amount of time is required to thoroughly examine all the data.

### BRIEF SUMMARY OF THE INVENTION

According to one aspect of the present invention, a user interface is provided. The user interface includes a display area to display at least one image from a plurality of images, with the images being organized into more than one series of images and having multiple images in at least some of the series. A user input device provides first and second types of user actions. The display area is adapted to display images from one of the series, if a first type of user action from the user input device occurs. The display area is adapted to display a corresponding image from a different series, if a second type of user action from the user input device occurs.

### BRIEF DESCRIPTION OF THE SEVERAL VIEWS OF THE DRAWINGS

FIG. 1 is a schematic view of a data collection system according to the prior art.

FIG. 2 is a schematic representation of the various images that may be obtained from a data collection system.

FIG. 3 shows an apparatus that can provide a user interface to display images in accordance with an embodiment of the invention.

FIGS. 4-6 show a user interface for displaying images within a same series according one embodiment of the present invention.

FIGS. 7-10 show use of the user interface of FIGS. 4-6 for displaying images (of a same slice number) from different series according to one embodiment of the present invention.

FIG. 11 shows an image from a series that can be displayed by the user interface of FIGS. 4-10 according to an embodiment of the present invention.

FIG. 12 shows a user interface for displaying images according to an embodiment of the present invention.

FIG. 13 is a flowchart illustrating a method for displaying images according to one embodiment of the present invention.

### DETAILED DESCRIPTION

Embodiments of a user interface for viewing images are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, one embodiment of the invention provides a user interface that may be used by medical personnel, such as radiologists, to view a large plurality of medical images for the purposes of diagnosis and determining a treatment regimen. The user interface greatly enhances the ability of medical personnel to locate images that have data of greater importance, understand the image data, and compare the data in one image with data in another image. This permits a more accurate assessment of the medical condition of the respective patient.

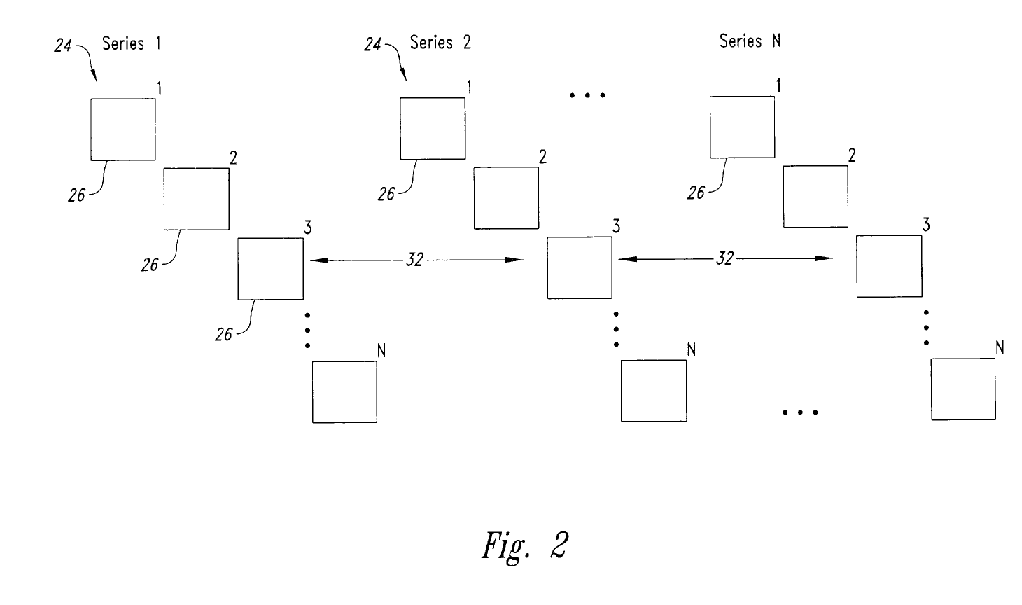

The medical images may be organized into one or more series, where each series is comprised of multiple images (often referred to as “slices”). As will be described in further detail below with respect to FIG. 2, a plurality of images in each series can comprise images taken from different cross-sectional locations of a patient's body, for instance. Thus, the images within an individual series have a spatial relationship with one another. Each series, in turn, can have a temporal (or other) relationship with the other series. For example where a contrast agent is used to provide enhanced images, one series can include pre-contrast images, one or more additional series can include post-contrast images (over a period of time), and another series can be a subtraction series. A particular slice in one series is generally “aligned” with another corresponding slice in any of the other series, in that the aligned slices are taken from the same cross-sectional location in the patient's body to form a “slice set.”

An embodiment of the user interface includes a display area to display the medical images. A first type of user action, such as “clicking and dragging” on a mouse button in a first direction, results in sequential display (in the display area) of slices from an individual series. A second type of user action, such as clicking and dragging on the mouse button in a second direction, results in sequential display of aligned slices from multiple series on the display area.

In an embodiment, dynamic scaling may be performed such that when the user clicks and drags from one end of the display area to another, all of the images corresponding to that type of user action are displayed. For instance, if there are 10 slices in a particular series, the display area can be “broken up” into 10 regions—as the user clicks and drags from the 1^{st} region to the 10^{th} region along the first direction, slices 1 through 10 are sequentially displayed in the display area. Scaling of the display area can be dynamically changed along a first direction if the other series have a different number of slices, or scaling of the display area can be dynamically changed along a second direction if aligned images are not available in some series. Other techniques (described below) may be used to determine when it is appropriate to transition from displaying one image to displaying another image.

One embodiment can include color overlays in some of the images, where the color highlights tissues of interest in the images. As another feature of an embodiment, the display area can concurrently display multiple images rather than one image at a time. Window and level adjustment control, via a third and fourth types of user action respectively, is provided in an embodiment along with the spatial and series scrolling through slices described above.

For purposes of explanation and illustration, embodiments of the invention will be described herein in the context of magnetic resonance imaging (MRI) and related analysis. It is appreciated that the invention is not limited to MRI and that other embodiments of the invention may be applied to other medical imaging technologies, including but not limited to, nuclear magnetic resonance (NMR), computed tomography (CT), positron emission tomography (PET), ultrasound, x-rays, and other imaging technique. It is also possible to display, during the same session, different types of images taken from a patient (e.g., CT images, PET images, or other images at the same spatial location). Some embodiments of the invention may also be used in connection with imaging technologies that are not necessarily medical in nature.

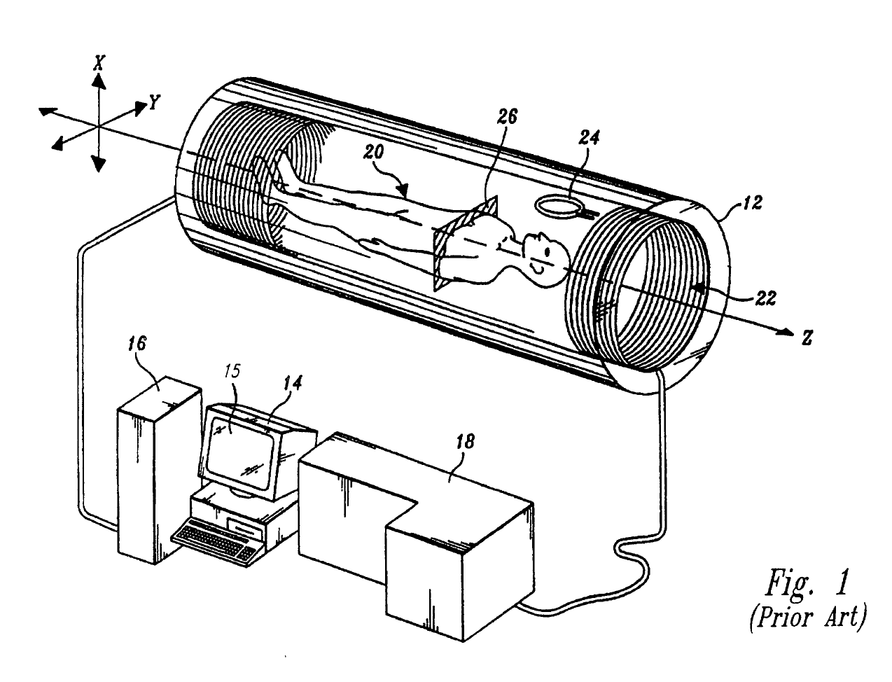

Beginning initially with FIG. 1, shown therein is a known sensor and data collection device as described in U.S. Pat. No. 5,644,232. It illustrates one technique by which data can be collected for analysis for use by one embodiment of the present invention.

Details of magnetic resonance imaging methods are disclosed in U.S. Pat. No. 5,311,131, entitled, “MAGNETIC RESONANCE IMAGING USING PATTERN RECOGNITION;” U.S. Pat. No. 5,644,232, entitled, “QUANTITATION AND STANDARDIZATION OF MAGNETIC RESONANCE MEASUREMENTS;” and U.S. Pat. No. 5,818,231, entitled, “QUANTITATION AND STANDARDIZATION OF MAGNETIC RESONANCE MEASUREMENTS.” The above-referenced three patents are incorporated in their entirety herein by reference. The technical descriptions in these three patents provide a background explanation of one environment for the invention and are beneficial to understand the present invention.

Pattern recognition is utilized in several disciplines and the application of thresholding as described with respect to this invention is pertinent to all of these fields. Without the loss of generality, the examples and descriptions will all be limited to the field of MRI for simplicity. Of particular interest is the application of pattern recognition technology in the detection of similar lesions such as tumors within magnetic resonance images. Therefore, additional background on the process of MRI and the detection of tumor using MRI is beneficial to understanding embodiments of the invention.

Magnetic resonance (MR) is a widespread analytical method used routinely in chemistry, physics, biology, and medicine. Nuclear magnetic resonance (NMR) is a chemical analytical technique that is routinely used to determine chemical structure and purity. In NMR, a single sample is loaded into the instrument and a representative, multivariate, chemical spectrum is obtained. The magnetic resonance method has evolved from being only a chemical/physical spectral investigational tool to an imaging technique, MRI, that can be used to evaluate complex biological processes in cells, isolated organs, and living systems in a non-invasive way. In MRI, sample data are represented by an individual picture element, called a pixel, and there are multiple samples within a given image.

Magnetic resonance imaging utilizes a strong magnetic field for the imaging of matter in a specimen. MRI is used extensively in the medical field for the noninvasive evaluation of internal organs and tissues, including locating and identifying benign or malignant tumors.

As shown in FIG. 1, a patient 20 is typically placed within a housing 12 having an MR scanner, which is a large, circular magnet 22 with an internal bore large enough to receive the patient. The magnet 22 creates a static magnetic field along the longitudinal axis of the patient's body 20. The magnetic field results in the precession or spinning of charged elements such as the protons. The spinning protons in the patient's tissues preferentially align themselves along the direction of the static magnetic field. A radio frequency electromagnetic pulse is applied, creating a new temporary magnetic field. The proton spins now preferentially align in the direction of the new temporary magnetic field. When the temporary magnetic field is removed, the proton spin returns to align with the static magnetic field. Movement of the protons produces a signal that is detected by an antenna 24 associated with the scanner. Using additional magnetic gradients, the positional information can be retrieved and the intensity of the signals produced by the protons can be reconstructed into a two- or three-dimensional image.

The realignment of the protons' spin with the original static magnetic field (referred to as “relaxation”) is measured along two axes. More particularly, the protons undergo a longitudinal relaxation (T₁) and transverse relaxation (T₂). Because different tissues undergo different rates of relaxation, the differences create the contrast between different internal structures as well as a contrast between normal and abnormal tissue. In addition to series of images composed of T₁, T₂, and proton density, variations in the sequence selection permit the measurement of chemical shift, proton bulk motion, diffusion coefficients, and magnetic susceptibility using MR. The information obtained for the computer guided tissue segmentation may also include respective series that measure such features as: a spin-echo (SE) sequence; two fast spin-echo (FSE) double echo sequences; and fast stimulated inversion recovery (FSTIR), or any of a variety of sequences approved for safe use on the imager. Further discussion of T₁-weighted and T₁-weighted images and the other types of images identified above (and various techniques to process and interpret these images) are provided in the co-pending application(s) referenced herein and in the available literature, and are not repeated herein for purposes of brevity.

Contrast agents are types of drugs that may be administered to the subject. If given, contrast agents typically distribute in various compartments of the body over time and provide some degree of enhanced image for interpretation by the user. In addition to the above, pre- and post-contrast sequence data series can be acquired.

When displayed as an image, the collected data can be represented as pixels, voxels, or any other suitable representation. Within the visual display, the intensity, color, and other features of the respective data point, whether termed a pixel, voxel, or other representation, provides an indication of the medical parameter of interest. (As used herein, the term “pixel” will be used in the broad, generic sense to include any individual component that makes up a visual image that is under examination and includes within the meaning such things as pixels, data point representing two-dimensional data, voxels having three or more dimensional data, a grayscale data point or other visual component from an MRI image, NMR, CT, ultrasound, or other medical image). The medical image thus contains a large number of pixels each of which contain data corresponding to one or more medical parameters within a patient, an entire image being made up of a large number of pixels.

In FIG. 1, an object to be examined, in this case the patient's body 20, is shown. A slice 26 of the body 20 under examination is scanned and the data collected. The data are collected, organized and stored in a signal-processing module 18 under control of a computer 14. A display 15 may display the data as they are collected and stored. It may also provide an interface for the user to interact with and control the system. A power supply 16 provides power for the system.

The current known clinical standard for locating tumor tissue with MRI involves having an experienced radiologist interpret the images for suspected lesions. Radiologists are skilled in detecting anatomic abnormalities and in formulating differential diagnoses to explain their findings. Unfortunately, only a small fraction of the wealth of information generated by magnetic resonance is routinely available because the human visual system is unable to correlate the complexity and volume of data. The specific problem is that radiologists try to answer clinical questions precisely regarding the location of certain tissues, but seldom can they extract enough information visually from the images to make a specific diagnosis because the tissues are very complex and therefore difficult to accurately segment in the image provided. This problem is compounded for MRI, which produces many different types of images during a single imaging session.

To use all of the information created by an MRI examination, radiologists have to simultaneously view several images created with different MR scanner settings and understand the simultaneous complex relationships among millions of data. The unassisted human visual system is not capable of seeing, let alone processing, all of the information. Consequently, much of the information generated by a conventional MRI study is wasted. Consequently, there is a great need to efficiently utilize more of the existing MR information to more accurately segment the various tissues and thereby improve the confidence of conclusions drawn from the interpretations of medical images. Because a proper determination of the location and the extent of a tumor (a process called staging) will determine the course of treatment and may impact the likelihood of recovery, accurate staging is important for proper patient management.

FIG. 2 illustrates the image data that may be collected according to one embodiment of the present invention and shows the problems that may be encountered by medical personnel, such as a radiologist's attempt to interpret the meaning of the various images. The medical images that are obtained can be considered as being organized in a number of different series 24. Each series 24 is comprised of data that is collected by a single technique and its corresponding imager settings. For example, one series 24 may be made up of T1-weighted images. A second series 24 may be made up of T2-weighted images. A third series 24 may be made up of a spin echo sequence (SE). Another series 24 may be made up of a STIR or inversion recovery sequence. A number of series may be obtained during the data collection process. It is typical to obtain between six and eight series 24 and in some instances, ten or more different series 24 of data for a single patient during a data collection scan. In one embodiment, the different series may have a temporal relationship relative to each other.

Each series 24 is comprised of a large number of images, each image representing a slice 26 within the medical body under examination. The slice 26 is a cross-sectional view of particular tissues within a plane of the medical body under interest. A second slice 26 is taken spaced a small distance away from the first slice 26. A third slice 26 is then taken spaced from the second slice. A number of slices 26 are taken in each series 24 for the study being conducted until N slices have been collected and stored. Under a normal diagnostic study, in the range of 25-35 spatially separated slices are collected within a single series. In other situations, 80-100 spatially separated slices are collected within a single series. Of course, in a detailed study, the number of slices 26 being obtained may be much higher for each series. For example, it may number in the hundreds in some examples, such as for a brain scan, when a large amount of data is desired, or a very large portion of the medical body is being tested.

Generally, each series 24 has the same number of slices, and further, a slice in each series is taken at the same location in the body as the corresponding slice in the other series. In some situations, slices indexed with the same number in the different series 24 are from the same location in the human body in each series. In other situations, slices in the different series 24 that are taken from the same location in the human body are indexed with different numbers. A slice set 32 is made up of one slice from each of the series taken at the same location within the medical body under study. For example, a group made of slice #3 from each of the series 24 would comprise a slice set 32 of aligned slices, assuming that all of the slices indexed as #3 are taken from the same spatial location within the body. Being able to assemble and understand the various data in a slice set 32 can be very valuable as a diagnostic tool.

If each series 24 has a certain number of slices, such as 30, and there are 6 to 8 series collected then the total number of images collected is in the range of 180 to 240 distinct and separate images. Just viewing each image individually is an extremely difficult, and burdensome task. Even if time permits that all the images can be all viewed, sorting them in a meaningful sequence and understanding the relationship among the various slices and various series is extremely difficult. Even though the image data are stored on a computer and the medical personnel have access to a computer database for retrieving and viewing the images, the massive amount of information contained in the various images together with the huge number of images that are available make properly reading and understanding all of the data in the images a very time consuming and difficult task. During the time consuming and difficult nature of the task of viewing, comparing, and correlating all of the various images the medical personnel may sometimes miss important diagnostic information within a particular image. If this diagnostic information is not properly viewed and interpreted as compared to the other images, errors may be made in understanding the patient's medical condition, which may result in errors related to the medical procedures and protocol used in caring for the patient.

One embodiment of the present invention provides a user interface that accurately and easily provides to the medical personnel access to all of the collected data for a particular patient. Such an interface is valuable in order to ensure that a proper medical diagnosis is made and that proper treatment is carried out for the particular patient based on accurate knowledge of their medical condition.

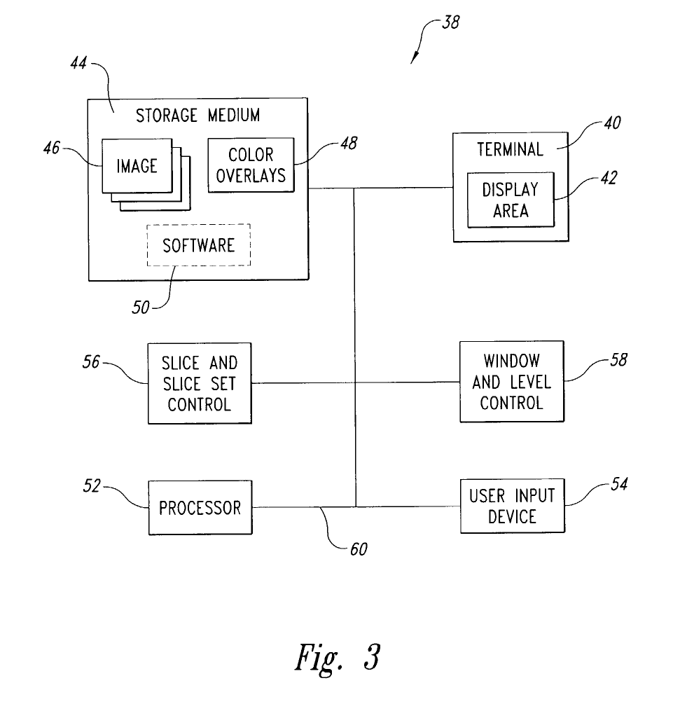

Components that can cooperate to provide such a user interface are illustrated in an embodiment of an apparatus 38 shown in FIG. 3. The apparatus 38 includes a terminal 40, which may be a personal computer, remote terminal connected to a network, wireless device, or other type of display device having a display area 42 adapted to display medical images. The display area 42 may be a computer screen, touch screen, or other type of display through which a user interface can be provided for use by medical personnel to view medical images.

The terminal 40 is coupled to a storage medium 44. The storage medium 44 can comprise one or more machine-readable storage media, such as a hard disk or server, that can store medical images 46. The medical images 46 can include multiple series of slices, such as depicted in FIG. 2 above, in digital image format or other suitable electronic format. The medical images 46 can be stored, organized, indexed, and retrievable from the storage medium 44 using techniques that would be familiar to those skilled in the art having the benefit of this disclosure.

In one embodiment, the storage medium can store color overlays 48. The color overlays 48 can be overlaid over black and white ones of the images 46, to highlight tissues of interest according to various color schemes. For example, tissue in some images that are extremely likely to be cancerous may be overlaid in red color, while less suspect tissue may be highlighted in blue color. In some embodiments, the color is integrated into black and white images 46, rather than or in addition to being overlays. Example techniques that may be used by one embodiment of the present invention to provide colored images for purposes of analysis and diagnosis are disclosed in U.S. patent application Ser. No. 09/990,947, entitled “USER INTERFACE HAVING ANALYSIS STATUS INDICATORS,” filed Nov. 21, 2001, assigned to the same assignee as the present application, and which is incorporated herein by reference in its entirety.

The storage medium 50 can store software 50 (or some other application or machine-readable instructions) that cooperates with other components of the apparatus 38 to provide the user interface and to process user actions entered via the user interface. For example and as will be described in further detail below with reference to subsequent figures, the software 50 can determine which image from the images 46 to display based on a particular type of user action entered via the user interface.

A processor 52 is coupled to the storage medium 44 and to the display area 42 to cooperate with the software 50 to display appropriate ones of the images 46 on the display area 42. The processor 52 also controls general operation of the apparatus 38.

The processor 52 and the software 50 determine which of the images 46 to display in the display area 42 based on signals received from a user input device 54. In one embodiment, the user input device 54 can comprise a mouse having a right and left button. In a first type of user action, if the left button is clicked and the mouse is then dragged up/down, slices within an individual series from the images 46 are displayed in the display area 42. In a second type of user action, if the left button is clicked and the mouse is then dragged right/left, aligned slices (or a slice set) from different series are displayed in the display area 42.

In one embodiment, the right button (if clicked) of the mouse may be used for window and level adjustment of the gray shades of the displayed images. Window and level are types of operator controls that are familiar to those skilled in the art, and therefore will not be explained in further detail herein. It is simply noted herein that a third type of user action (such as clicking on the right button and dragging the mouse right/left) adjusts the window, while a fourth type of user action (such as clicking on the right button and dragging the mouse up/down) adjusts the level.

While a mouse with two or more buttons has been described as one example implementation of the user input device 54, it is appreciated that the user input device 54 may be different types of devices in other embodiments. For example, the user input device 54 may be a trackball in one embodiment. In another embodiment, the user input device 54 and the display area 42 may be integrated as a touch screen. In yet other embodiments, the user input device 54 may be a wireless device having multiple buttons dedicated to certain types of user action, or the user input device 54 may be a touch pad.

In an embodiment, the apparatus 38 can include a slice and slice set control block 56. The control block 56 can comprise an interface to the processor 52 and to the software 50, for instance, to generate signals or interrupts based on detected user action entered via the user input device 54 to scroll through slices in a series or between slices in a slice set. The apparatus 38 can also include a window and level control block 58. The control block 58 can comprise an interface to the processor 52 and to the software 50, for instance, to generate signals or interrupts based on detected user action entered via the user input device 54 to adjust window and level. In some embodiments, the functionality of the control blocks 56 and 58 may be integrated in the combination of the user input device 54, the processor 52, and the software 50.

A bus 60 is symbolically shown as coupling the components of the apparatus 38 together. It is appreciated that the apparatus 38 may contain more or fewer components than what is specifically shown in FIG. 3. Moreover, some of the components may be combined or integrated together, rather than being separate components.

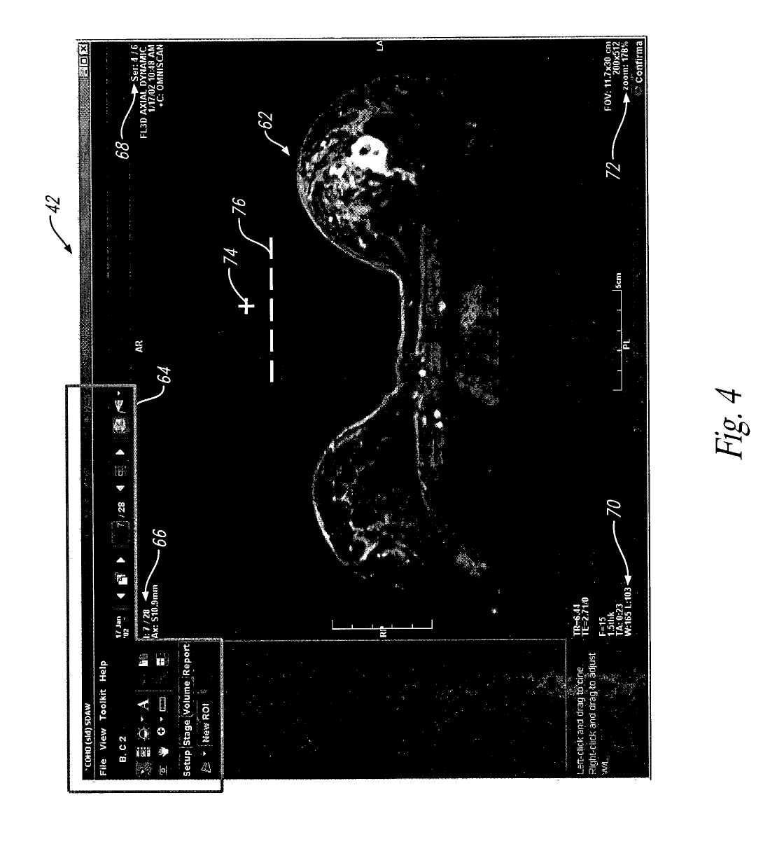

FIGS. 4-12 are various screen shots depicting one or more embodiment(s) of a user interface. It is appreciated that the user interface(s) depicted therein are merely illustrative. Other embodiments can provide user interfaces with different layouts, informational displays, controls, displayed images, and the like. Moreover, the clicking and dragging (or other feature) that is depicted in some of the figures are not necessarily drawn to scale.

FIG. 4 illustrates a user interface for use by medical personnel for examining medical images according one embodiment of the present invention. The user interface includes a computer screen (such as the display area 42) having a medical image 62 shown thereon. The medical image 62 can be one of the images 46 stored in the storage medium 44. The medical image 62 is shown as one example for illustrating examination for breast cancer and a study of whether or not the cancer has metastasized and spread to other tissues within the patient. Of course, principles of the invention are equally applicable to all sorts of medical images of different parts of the body or to images that are not necessarily medical in nature. One embodiment of the invention may be particularly beneficial for brain image data, lymph node image data, or many other types of tissue that are susceptible to cancers or other diseases that spread to different locations within the body.

The medical image 62 may have a region of interest, within which pixels can be studied in order to assist in the medical diagnosis. Within regions of interest, co-pending U.S. application Ser. No. 09/990,947 discloses example techniques for clustering of the various types of tissue and for applying a color scale image to the various clusters of data using the appropriate color scheme, such as grayscale, light tone colors or others that the user may select in order to give the greatest contrast and highlight of the tissues under study. An acceptable technique for selecting a region of interest, performing clustering, and then carrying out analysis on the pixels of the medical image data are described in copending U.S. patent application Ser. No. 09/722,063, entitled “DYNAMIC THRESHOLDING OF SEGMENTED DATA SETS AND DISPLAY OF SIMILARITY VALUES IN A SIMILARITY IMAGE,” filed on Nov. 24, 2000, assigned to the same assignee of the present application, and which is incorporated herein by reference in its entirety. Also of interest is U.S. patent application Ser. No. 09/721,931, entitled “CONVOLUTION FILTERING OF SIMILARITY DATA FOR VISUAL DISPLAY OF ENHANCED IMAGE,” filed on Nov. 24, 2000, and which is also assigned to the same assignee of the present application and incorporated herein by reference in its entirety. For the sake of brevity, the details disclosed in these co-pending applications are not repeated herein.

The user interface according to one embodiment of the present invention is particularly beneficial for organizing medical records and diagnosing medical conditions. On the single user interface screen are contained convenient tools 64 in a compact, easy-to-use format to aid in proper understanding of the large amount of image data that is stored in the storage medium 44. These tools 64 can include menu bars, indicators, commands, identifiers, informational data regarding the displayed medical image 62, user controls, and the like. More detailed explanation of the tools 64 can be found in the co-pending U.S. application Ser. No. 09/990,947 identified above, and are not repeated herein for the sake of brevity.

A slice indicator 66 identifies the slice number of the currently displayed medical image 62, while a series indicator 68 identifies the series number that the medical image 62 belongs to. For example in FIG. 4, the slice indicator 66 is displaying “7/28” and the series indicator 68 is displaying “4/6.” This information indicates, therefore, that the currently displayed medical image 62 is slice #7 of 28 slices, with the 28 slices belonging to series #4 of 6 available series. It is noted that while “28” slices for series #4 is explained hereinafter, there may be many more slices that are actually available in series #4, such as 80-100 slices, where a particular group of 28 slices has been chosen for review in this specific example. The user is free to select to view all 80-100 slices (for example) during upward/downward dragging, or just a selected group (e.g., 28 slices) from the total number of available slices.

A window/level indicator 70 indicates window and level values, which is respectively set at 165 and 103 for the medical image 62 of FIG. 4. A magnification indicator 72 indicates a magnification of the medical image 62, which is set at 178% in FIG. 4.

According to one embodiment of the invention, the user can scroll/display from one slice to another slice in the same series via a left-button click and up/down drag of a mouse button (e.g., the user input device 54). In FIG. 4, the display area 42 can be conceptually broken up into 28 regions along the vertical y-axis (for series #4 having 28 slices—the display area 42 can be broken up into different numbers of regions for other series having different numbers of slices). As the user clicks and drags from one region into another region, the displayed slice within series #4 will correspondingly change.

As shown in FIG. 4, a transition line 76 depicts a boundary between a signal to render slice #7 and a signal to render slice #8 in series #4. The transition line 76 is not usually shown on the display area 42 and is presented in the figures for illustration purposes. Thus, if a cursor 74 is positioned above the transition line 76, the medical image 62 is displayed. As the cursor 74 is dragged upward and away from the transition line 76 in a generally vertical direction along the y-axis, other transition lines are crossed, thereby resulting in the sequential display of slice #6, #5, #4, etc. on the entire display area 42.

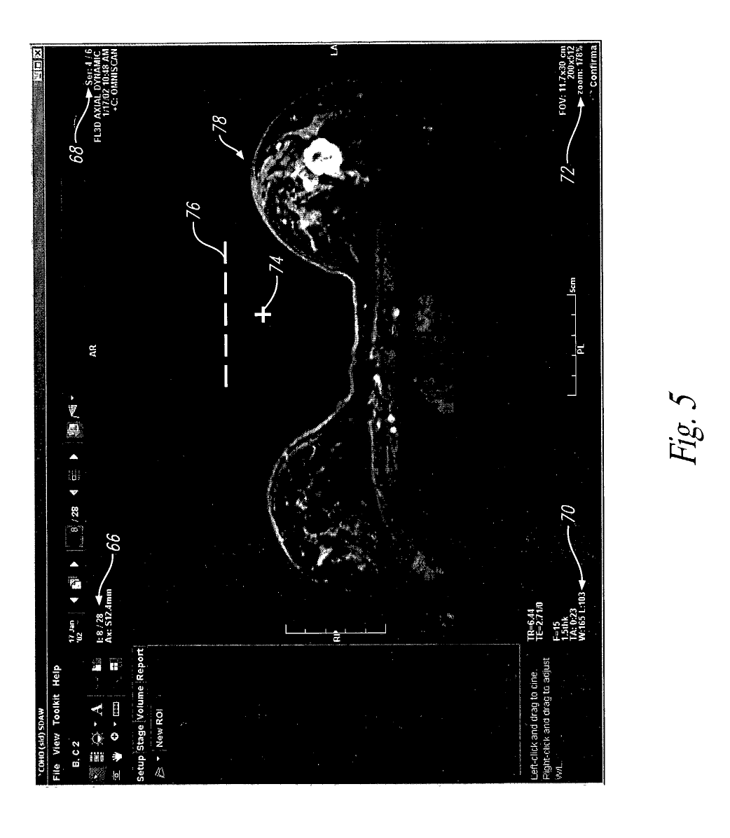

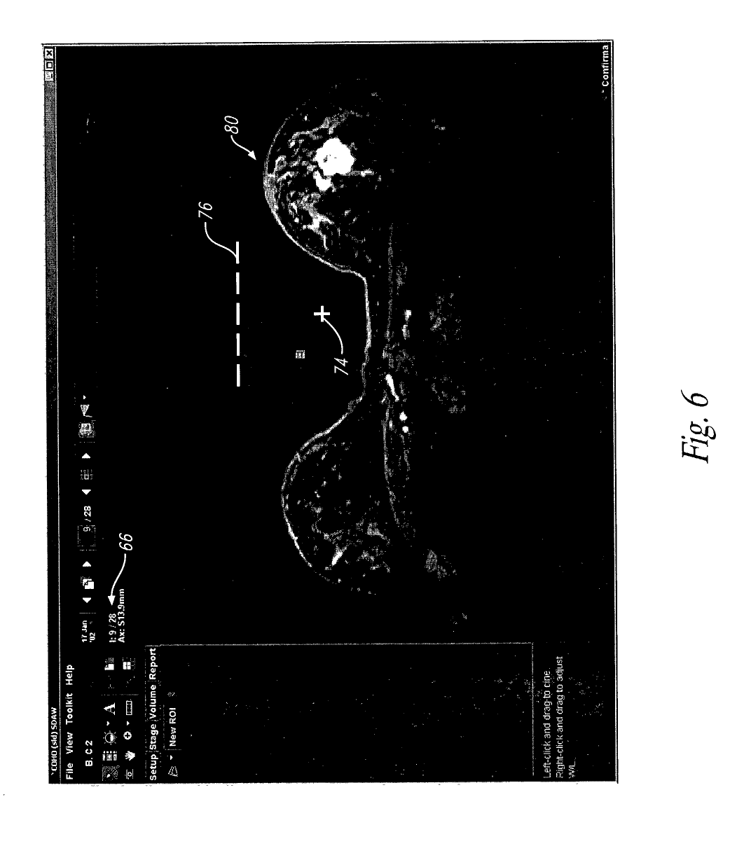

If the cursor 74 is dragged in a generally vertical direction downward past the transition line 76, the next slice(s) in the same series #4 are displayed. For example, FIG. 5 shows a next medical image 78 (e.g., slice #8, as indicated in the slice indicator 66) in the same series #4, after the cursor 74 has been dragged to a location just below the transition line 76. This medical image 78 is spatially distant from the prior medical image 62. FIG. 6 illustrates a next incremental medical image 80 in series #4 (e.g., slice #9, as indicated in the slice indicator 66) when the cursor 74 is further dragged vertically downward and away from the transition line 76, so that the cursor 74 crosses another transition line (not shown). Thus, by clicking and dragging along a generally vertical direction, spatial scrolling through slices within an individual series can be performed.

One of the above-described embodiment(s) illustrate a situation where the screen is conceptually “broken up” into 28 regions along the vertical axis, wherein scrolling from one region to another results in a corresponding transition of images. When starting a session, the user need not necessarily initially place the cursor 74 near the top of the display area in order to view slice #1, or near the bottom edge to view slice #28. That is, in one embodiment, initially placing the cursor at a random location on the display area (such as near the middle) results in the rendering of slice #1. Then, if the cursor is moved downward, for instance, until the edge of the display area is reached, the subsequent slices #2-#15 are rendered. Then, if the cursor 74 is moved back upward to another location and subsequently moved/scrolled downward again, the remaining slices #16-#28 are rendered. Several different variations are possible for relative cursor positioning and movement, and which images are rendered as the result of the cursor activity.

In an embodiment, once a slice has been selected in a series, moving the image data (such as by scrolling) from one series to another will display an aligned slice in the different series. In situations where aligned slices are indexed similarly (e.g., slice #5 in one series spatially corresponds to slice #5 in another series), images having the same slice numbers (and same spatial location) are sequentially displayed. In situations where the indexing is different between some of the series (e.g., slice #5 in one series spatially corresponds to slice #13 in another series), images corresponding to the same spatial location are also sequentially displayed during the scrolling. This may be performed via a left-button click and left/right drag along the x-axis of the display area 42 in one embodiment. Thus, in a situation where aligned slices are indexed with the same slice numbers, the medical personnel may look at slice #9 in the T1 series data, then slice #9 within the T2 series data, then in the same slice #9 in the stir series, or any aligned slice in any of the other desired series. Where a contrast agent is used, or in other appropriate situations, the different series may provide images having a temporal relationship to one another (e.g., pre-contrast images, post-contrast images, washout, and the like). The ability to rapidly examine the same relative slice in each of the series provides significant advantages in performing medical diagnosis. This provides tremendous advantages to medical personnel who wish to compare a slice within one series to another within a particular medical body of interest. Additionally, slices can be organized in a slice set and have each slice from the set displayed simultaneously, or in sequence, one after the other so as to provide improved interpretation and reading by medical personnel.

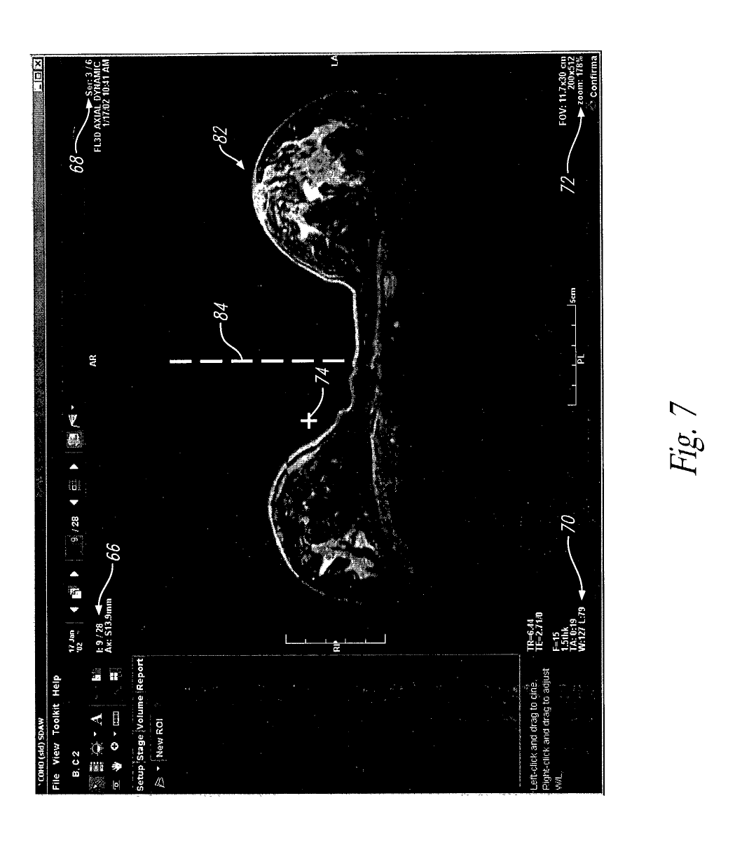

FIGS. 7-10 illustrate use of the user interface to scroll between a slice set (e.g., slices from different series but being aligned to the same spatial location). Beginning first with FIG. 7, a medical image 82 is rendered by the user interface when the cursor 74 is positioned in the appropriate location shown. The medical image 82 is slice #9 of 28 slices, in series #3 of 6 series, as respectively indicated by the slice indicator 66 and the series indicator 68.

It is noted that in FIG. 7, the window and level values have been changed to 127 and 79, respectively, as indicated by the window/level indicator 70. In one embodiment, the window value may be changed by right-button clicking and left/right dragging on the mouse. The level value may be changed by right-button clicking and up/down dragging on the mouse. This adjustment of the window and level values results in changes in the gray levels of the medical image 82 to improve resolution and viewing.

Since there are 6 series present, the display area 42 may be conceptually viewed as being broken up into 6 vertical regions. Movement from one region to another region (by clicking and dragging) across imaginary transition lines (such as the transition line 84) results in a transitional display from one slice in one series, to another slice (having the same slice number or spatial location) in the next incremental series. The transition line 84, like the transition line 76, need not be visually or physically rendered on the display area 42. It is shown here to illustrate operation of an embodiment of the invention. This transition line 84 (and other transition lines) can, of course, be positioned at different locations on the user interface. Moreover, as mentioned above, variations may be used to determine when a transition from one image to another is appropriate, based on relative cursor positioning and movement.

Therefore in FIG. 7, the cursor 74 is positioned in a location that corresponds to slice #9 in series #3. The cursor 74 may be dragged in a generally horizontal direction along the x-axis to display, on the entire display area 42, slice #9 in series #2 and in series #1 (if dragged to the left), or to display slice #9 in series #4 through series #6 (if dragged to the right). Again, the illustrated example is for a situation where aligned slices in the different series are indexed with the same slice numbers—identically index-numbered slices need not necessarily be used in order to view aligned slices.

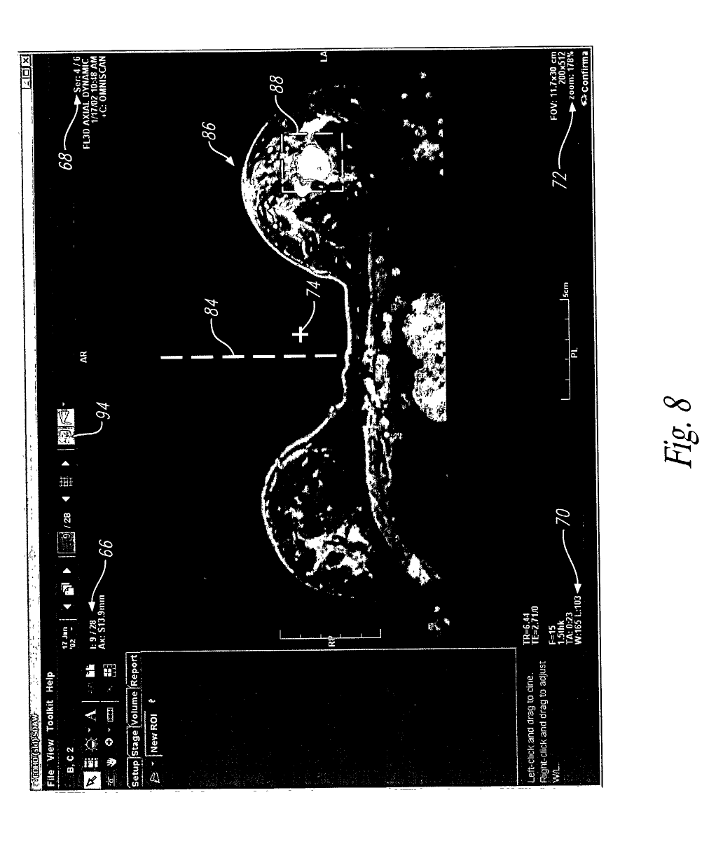

FIG. 8 shows slice #9 (e.g., a medical image 86) of the next series #4 when the cursor 74 is dragged just past the transition line 84. The medical image 86 of FIG. 8 is similar to the medical image 80 of FIG. 6, in that they both show slice #9 from series #4. However, for purposes of illustrating a feature that can be implemented by an embodiment of the invention, the medical image 86 of FIG. 8 includes color overlays 88 to highlight tissues of interest.

An overlay analysis button 94 permits the user to input a command to overlay on top of the visual image 86 a color scale showing the results of a performed image analysis. Clicking on the overlay analysis button 94 toggles the color overlay from being on to being off. This permits the user to view the data with the enhanced color overlay showing the results of analysis for a similar tissue segmentation for aid in locating the spread of malignant tumors and cancer cells. Pressing the overlay analysis button 94 again toggles the feature off so as to provide the original visual image without modification. In other embodiments, color may be integrated into the image rather than or in addition to being overlays.

The on/off analysis overlay button 94 provides advantages to the user in providing an easy way to quickly switch from viewing the computer analyzed visual image and the unanalyzed visual image. Once the analysis has taken place, which may take a period of time since it is very data intensive and a large dataset is involved, the results are stored. The user can therefore view the visual image with the analysis color overlay present and then turn off the visual display to the analysis. It is still saved in a stored file and can be quickly and easily recalled and applied to the visual image with a simple click of the analysis overlay button 94.

The user can click and drag through a slice set with the color overlay turned on or turned off for all of the slices, or turned on/off for just selected ones of the slices. In FIG. 7, for instance, the user may have chosen not to turn on the color overlay for the medical image 82, and then when the user scrolled to the medical image 86 of FIG. 8, the user turned on the color overlay feature to provide a color parametric overlay for slice #9 in series #4.

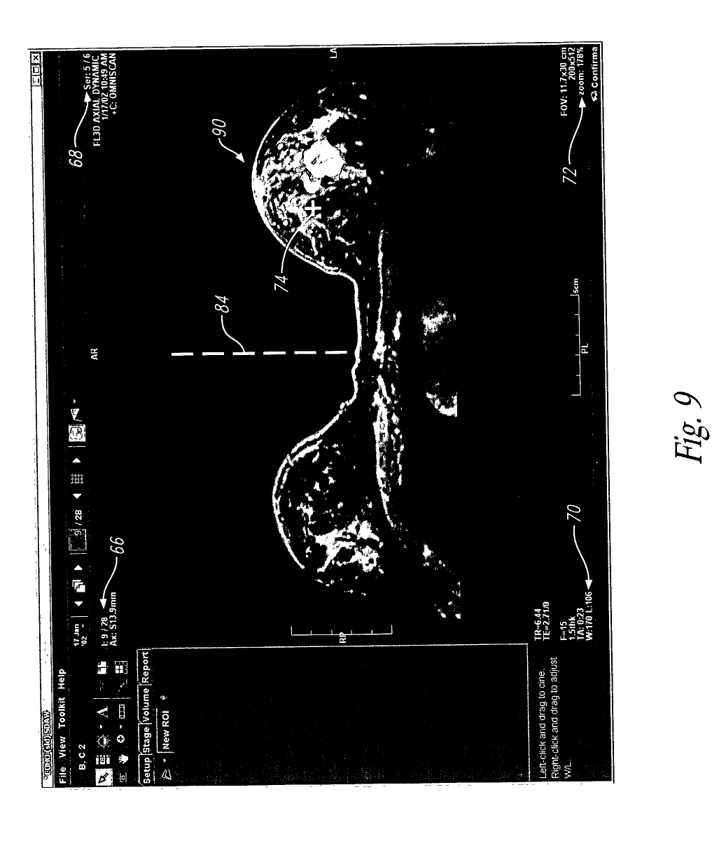

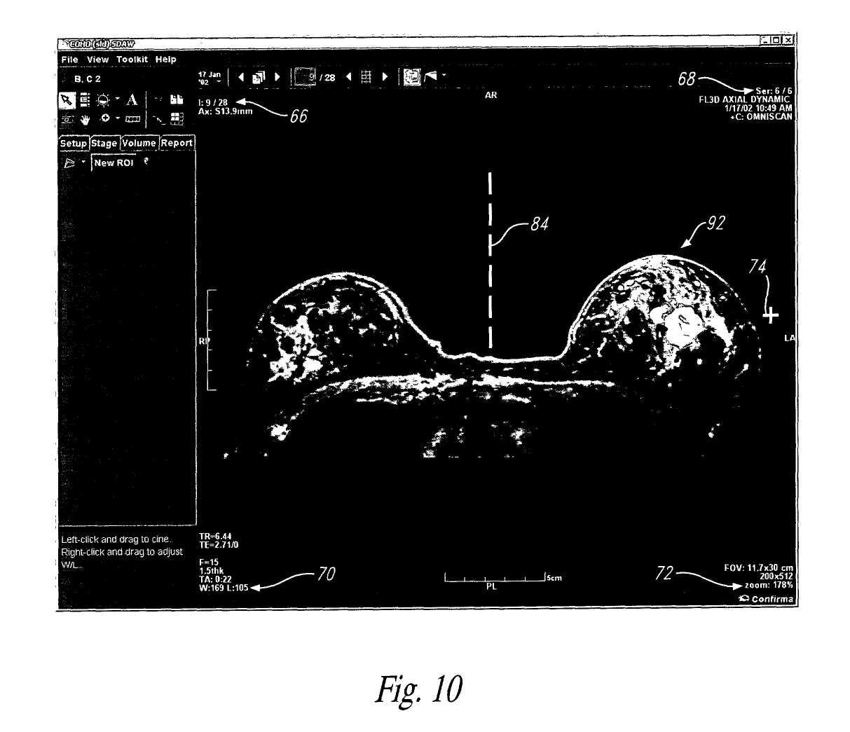

FIGS. 9-10 shows slice #9 from the next sequential series #5 and #6, as the user continues to click and drag in a generally horizontal direction towards the right and away from the transition line 84. Other transition lines (not shown) are crossed as each medical image 90 and 92 is rendered. As depicted in FIGS. 9-10, the color overlay is turned off in these particular images, and the window/level indicator 70 shows different values that the user has chosen. It is also noted that in FIG. 10, the cursor 74 is positioned near the extreme right edge of the display area 42, which indicates that the user has reached the last available series #6.

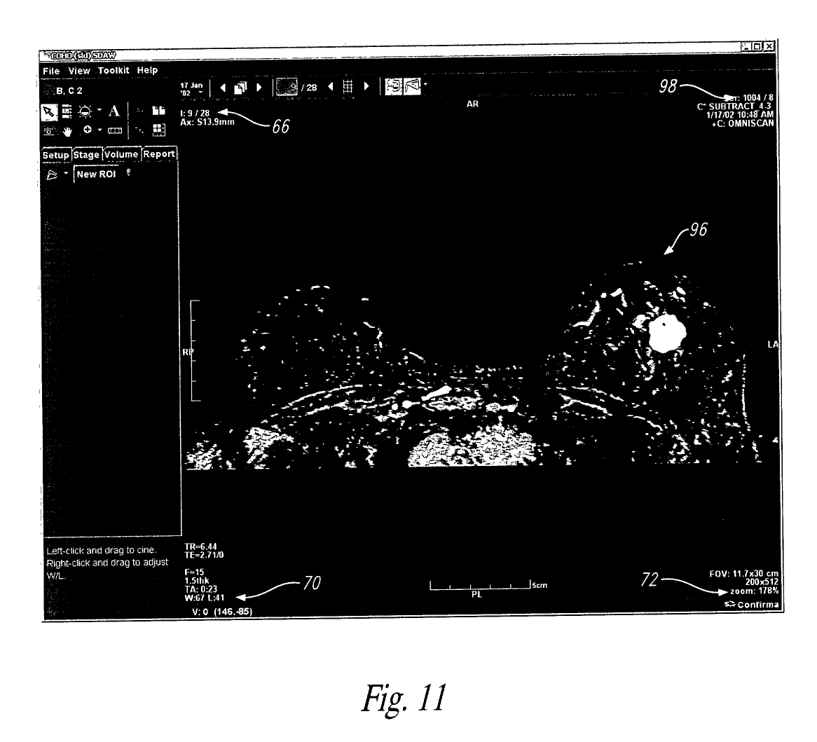

To illustrate another use of the user interface, FIG. 11 shows an image 96 from a slice #9 in a “subtraction” series. For purposes of this explanation, the series having the image 96 may (or may not necessarily) form part of the series identified and discussed in the preceding figures. A “subtraction” series provides images having a difference in contrast between two other series. For instance as indicated by an indicator 98, the subtraction series is taken from a subtraction of images in series #3 from images in series #4. Thus, the image 96 is obtained from subtraction of the same slice number images in these two series. The user can obtain the subtraction series by subtracting from any two desired series. Reviewing the contrasts provided in a subtraction series further assists medical personnel in properly diagnosing the condition of patients.

In a typical implementation, images to be used in a subtraction series may be taken according to a temporal procedure. For example, a first series may provide images prior to application of a contrast agent. Then, one or more subsequent additional series may provide several post contrast images, as washout occurs, over a period of time. The pre-contrast series is then subtracted from one of the post-contrast series to obtain a subtraction series.

Using the left-button click and drag from left to right, as described above, the user may then scroll to sequentially view a particular aligned slice from a pre-contrast series, to a post-contrast series, to a subtraction series. It is appreciated that it is possible to view more than one subtraction series as the user clicks and drags from left to right, such as if several subtraction series are generated by subtracting multiple different pairs of prior series.

In one embodiment, a left-button click and right/left drag results in the display of different types of images from the same spatial location. Thus, one set of MR-type images of aligned slices may be displayed when the cursor 74 is dragged right/left, and PET or CT or other types of images from the same spatial location are displayed when the user continues to drag the cursor 74 right or left. It is also noted that left-button clicking and dragging up/down can also result in the sequential display of PET or CT or other type of images of a series, while the other available scrollable series are MR-type images.

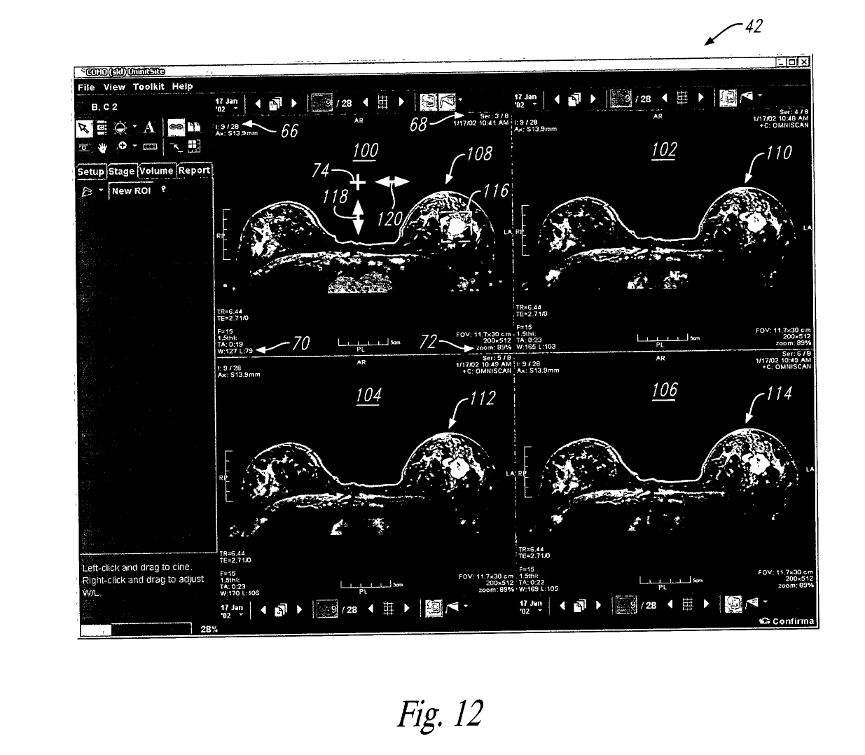

FIG. 12 illustrates a user interface in accordance with an embodiment of the invention. In FIG. 12, the display area 42 is apportioned into four display regions 100, 102, 104, and 106 that respectively display medical images 108, 110, 112, and 114. Each display region 100-106 has a slice indicator 66, a slice indicator 68, a window/level indicator 70, and a magnification indicator 72. As depicted in the example, a different window/level setting can be set for each display region 100-106, while the magnification may be the same in each display region 100-106 or set differently. In this illustration, the magnification is set at 89% so as to fully accommodate all four images 108-114 on the display area 42.

In the example of FIG. 12, the images 108-114 are of slice #9 in series #3-#6. In slice #9 in series #3 in the display region 100, a color overlay has been turned on to highlight tissues of interest 116 in the image 108. In the other images 110-114, the color overlay feature is turned off.

Assume for instance that the user left-button clicks and drags the cursor 74 in a generally vertical direction 118 within the display region 100. This user action results in the display of subsequent (or preceding) slices within the same series in each of the display regions 100-106. For example, if the cursor 74 is dragged downward, each display region 100-106 will concurrently change and display slice #10 and onward.

Assume next that the user left-button clicks and drags the cursor 74 in a generally horizontal direction 120 within the display region 100. This user action results in the display of an aligned slice from subsequent (or preceding) series in each of the display region 100-106. Thus, if the cursor 74 is dragged towards the right, the image in the display region 100 will transition from the image 108 in series #3 to the image 110 in series #4; the image in the display region 102 will transition from the image 110 in series #4 to the image 112 in series #5; and so on, up to the display region 106 where there will be a transition from the image 114 in series #6 to slice #9 in series #7.

The slices are thus linked together so that when the user moves from one slice to another slice within a series, the visual display for the other series will also move to a matching slice within their own series. Similar linking occurs when the user scrolls from series to series. The user may thus have a slice from four different series displayed at the same time and be assured that the same slice from each series representing the same region in the medical body under study will be simultaneously displayed from each of the four series at the same time on the screen.

It is appreciated that the cursor 74 may be placed/clicked in any suitable location in any one of the display regions 100-106, and then dragged from that location in a manner described above to correspondingly change the image displayed in the display regions 100-106. It is also appreciated that instead of four display regions 100-106, any suitable number of display regions may be provided. The individual display regions may be broken up into the appropriate number of transition lines (such as the transition lines 76 and 84) to demarcate where the user has to cross (by dragging the cursor 74, for instance) in order to transition from one image to another.

The examples shown in the preceding FIGS. 4-12 may be thought of as being somewhat similar to a “cinema,” where one screen shot changes to another screen shot at a certain speed. Once in cinema mode, the user can scroll rapidly through an entire series (or the aligned slices in different series), with the rate of scroll being controlled by the user. The user, by rolling the mouse wheel, or left-clicking and moving the mouse (or other user action technique) while in cinema mode moves from one slice to the next slice (or from one series to another) at a rate proportional to the rate at which the button is rolled or the mouse is moved. The user can thus move rapidly but at a user-selected speed through an entire series (or between series) so as to help construct an overall understanding of the medical diagnosis for the patient under study.

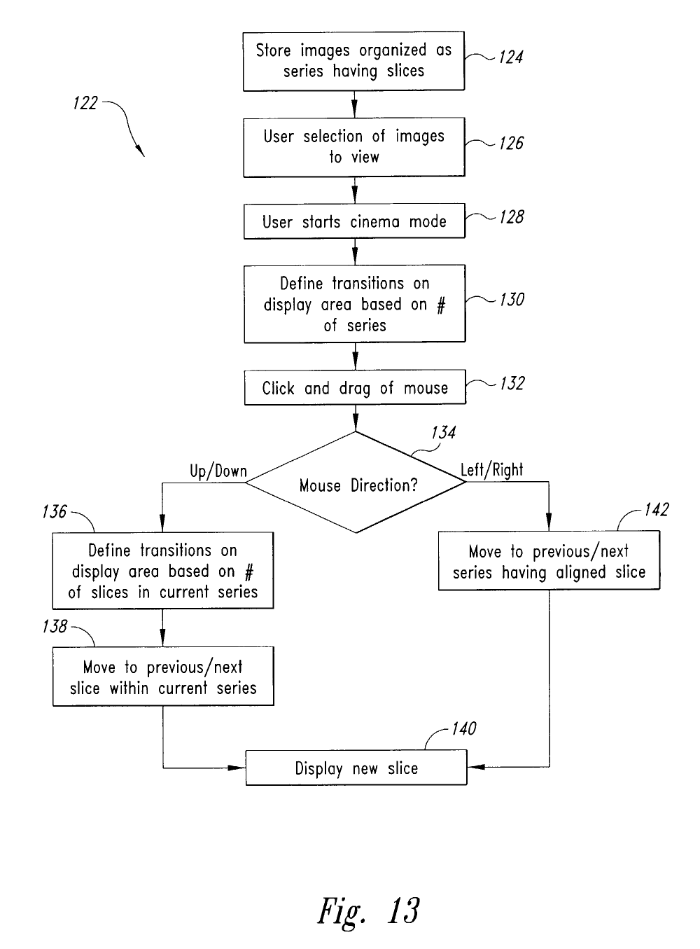

FIG. 13 is a flowchart illustrating a method 122 for displaying images according to one embodiment of the present invention. Elements of the method 122 may be embodied in software or other machine-readable instruction stored on a machine-readable medium, such as the storage medium 44 of the apparatus 38. Moreover, elements of the method 122 need not necessarily occur in the exact order shown, and/or may be combined in some embodiments.

Beginning at a block 124, images 46 are stored in the storage medium 44. Some of these images may include the color overlays 48. In one embodiment, the stored images are organized into a plurality of series each having image slices. Corresponding slices (e.g., aligned slices) between each series may be linked or otherwise indexed with one another to form slice sets. Different images for each patient or other object of study may be stored at the block 124. Any suitable image storing technique may be used at the block 124.

Next at a block 126, the user selects which group of images to view. For instance, a radiologist may select a plurality of series of MRI images taken from a particular patient, in order to diagnose the condition of that patient.

At a block 128, the user starts a cine(ma) mode, where the user can view images by clicking and dragging as depicted in FIGS. 4-12 above. The user may enter the cine mode, for instance, by choosing that setting from one of the tools 64 depicted in FIG. 4.

Once the cine mode has been entered in the block 128 and after selection of a particular set of images to view at the block 126, the number of available series is known. Based on this known number of series, the left/right dragging transitions in the display area 42 (to scroll from one series to another) may be defined at a block 130. For example, if the known total number of series for that particular patient is four, then three generally vertical transitional lines may be dynamically defined on the display area 42 (but hidden from the user), over which the cursor 74 needs to cross to scroll from one series to another.

It is appreciated that other techniques may be used at the block 130 to determine when a transition to another image is appropriate. For example, the number of transitional lines and regions on the display area 42 may be fixed rather than dynamic. Alternatively or in addition, transitions may be based on a percentage of movement or cursor displacement on the display area 42. Still alternatively or in addition, the transitions may be based on motion measured from the user input device, rather than from the display area 42.

In one embodiment, cursor displacement for purposes of determining when an image transition is appropriate may be based on pixel count. First, the initial position of the cursor 74 is tracked. Then, pixels are counted to determine if the cursor movement is “mostly” left or right, or “mostly” up or down. If certain threshold numbers of pixels are exceeded during the movement of the cursor, then the appropriate image transition is made. Such an embodiment, reduces the amount of inadvertent image transitions due to “shaky” user hands.

At a block 132, a click and drag of the mouse is detected and processed. If it is a right-button click and drag, then window and/or level is adjusted. If it is a left-button click and drag, then display of images within an individual series or display of aligned slices within different series result. Whether it is a right-button click or a left-button click determines which mode is entered (e.g., window/level or slice/series scrolling). It is also appreciated that the user can go back and forth between these two modes, such as when the user changes the window/level while scrolling between series. In one embodiment, the controls 56 and 58 of FIG. 3 can process the user input from the user input device (e.g., mouse) and generate the interrupts therefrom.

Assuming that the user action is determined to be a left-button click and up/down drag at a block 134, thereby indicating a user desire to scroll between images in the same series, then one embodiment of the method 122 dynamically defines transitions on the display area 42 based on the number of slices in the current series at a block 136. For instance if a lookup of the storage medium 44 determines that there are 28 slices in the current slices, then 27 horizontal transitional lines are defined on the display area 42, over which the cursor 74 needs to cross to transition from one slice to another.

As previously mentioned above, other techniques may be used to determine when transitions from one image to another are appropriate. Moreover, the transition definitions need not occur in the exact location shown for block 136, and may be performed in other locations, such as at the block 130.

The images within the current series are displayed at a block 140, based on the direction of the user's dragging to move to a previous/next slice at a block 138. The process method may repeat as need to view additional images from the same patient or from another patient.

If back at the block 134 it is determined that the user had left-button clicked and dragged left/right, then that user action results in movement from a previous/next series having the aligned slice at a block 142. The corresponding slices from the different series are then displayed at the block 140.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention and can be made without deviating from the spirit and scope of the invention.

For instance, the image under study can be any acceptable image for which a detailed investigation is to be performed by comparing images of the same object to each other or images of one object to images of another object. In one embodiment, the object under study is human tissue and the region of interest corresponds to cells within the human body having a disease or particular impairment, such as cancer, Alzheimer's, epilepsy, or some other tissue that has been infected with a disease. Alternatively or in addition, the region of interest may be certain types of tissue that correspond to body organs, muscle types or certain types of cells for which an analysis or investigation is desired. As a further alternative or addition, the object under investigation may be any physical object, such as an apple, bottles of wine, timber to be studied, or other detailed object for which an analysis is to be performed and a search made for similar regions of interest within the object itself, or for one object to another.

Moreover, it is possible to provide one or more images that have annotations or other type of appropriate modification performed by the user to assist in viewing and processing the images. Such images may be scrolled along with other images in a manner described above with reference to FIGS. 4-12.

As yet another modification, images may be scrolled as every other image, every third image, or other sequence different from display of each image one at a time in their sequential order.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
storing a plurality of images, the images being organized into more than one series of images and having multiple images in at least some of the series;
if a first type of user action is detected, displaying images from one of the series; and
if a second type of user action is detected, displaying a corresponding image from a different series.

2. The method of claim 1 wherein the images include medical images of tissue.

3. The method of claim 2 wherein the medical images include magnetic resonance images.

4. The method of claim 1 wherein displaying the images from one of the series includes displaying spatially related slices organized into that series.

5. The method of claim 1 wherein displaying the corresponding images from the different series includes displaying a temporally related plurality of series.

6. The method of claim 1 wherein the first and second types of user actions are provided via a mouse, wherein the first type of user action includes a click and drag of the mouse along a first direction, and wherein the second type of user action includes a click and drag of the mouse along a second direction different from the first direction.

7. The method of claim 6, further comprising:
if a third type of user action is detected, changing a window setting of a currently displayed one of the images; and
if a fourth type of user action is detected, changing a level setting of the currently displayed one of the images.

8. The method of claim 1, further comprising displaying a color along with one of the images.

9. The method of claim 1 wherein displaying the images from one of the series includes displaying spatially related slices organized into that series, and wherein displaying the corresponding images from the different series includes displaying slices from the different series that are in a same spatial location.

10. The method of claim 1, further comprising:
concurrently displaying images from the different series on separate display regions, wherein:
if the first type of user action is detected, the method includes changing, on the display regions, the images from the one of the series; and
if the second type of user action is detected, the method includes changing, on the display regions, the corresponding images from different series.

11. The method of claim 1, further comprising:
determining a number of images in a particular one of the series;
determining a number of series;
defining a transition from a display of one image to another image within the particular one of the series based on the determined number of images; and
defining a transition from a display of one image to another image between different series based on the determined number of series.

12. The method of claim 11 wherein defining the transitions include dynamically dividing a display area with transition lines based on the determined numbers.

13. An article of manufacture, comprising:
a machine-readable medium having instructions stored thereon to:
access a plurality of stored images, the images being organized into more than one series of images and having multiple images in at least some of the series;
display images from one of the series, if a first type of user action is detected; and
display a corresponding image from a different series, if a second type of user action is detected.

14. The article of manufacture of claim 13 wherein the instructions to display the images from one of the series include instructions to display spatially related slices organized into that series, and wherein the instructions to display the corresponding images from the different series include instructions to display slices from the different series that are in a same spatial location.

15. The article of manufacture of claim 13 wherein the machine-readable medium further includes instructions stored thereon to process interrupts corresponding to the first and second types of user actions that are provided via a mouse, wherein the first type of user action includes a click and drag of the mouse along a first direction, and wherein the second type of user action includes a click and drag of the mouse along a second direction different from the first direction.

16. The article of manufacture of claim 13 wherein the machine-readable medium further includes instructions stored thereon to:
concurrently display images from the different series on separate display regions;
responsively change, on each of the display regions, the images from the one of the series, if the first type of user action is detected; and
responsively change, on the display regions, the corresponding images from different series, if the second type of user action is detected.

17. The article of manufacture of claim 13 wherein the machine-readable medium further includes instructions stored thereon to:
determine a number of images in a particular one of the series;
determine a number of series;
define a transition from a display of one image to another image within the particular one of the series based on the determined number of images; and
define a transition from a display of one image to another image between different series based on the determined number of series.

18. A system, comprising:
a means for storing a plurality of images, the images being organized into more than one series of images and having multiple images in at least some of the series;
a means for displaying images from one of the series, if a first type of user action is detected; and
a means for displaying a corresponding image from a different series, if a second type of user action is detected.

19. The system of claim 18, further comprising a means for providing the first and second types of user actions.

20. The system of claim 18 wherein the means for displaying the images from one of the series includes means for displaying spatially related slices organized into that series, and wherein the means for displaying the corresponding images from the different series includes a means for displaying slices from the different series that are in a same spatial location.

21. The system of claim 18, further comprising a data collection means for generating the plurality of images.

22. An apparatus, comprising:
a storage medium to store a plurality of images, the images stored in the storage medium being organized into more than one series of images and having multiple images in at least some of the series;
a display area coupled to the storage medium;
a user input device to provide first and second types of user actions; and
a processor coupled to the user input device and adapted to cooperate with a software program to process the first and second types of user actions provided by the user input device, the processor being adapted to cooperate with the software program to display images from one of the series on the display area if the first type of user action is detected, the processor being adapted to cooperate with the software program to display a corresponding image from a different series on the display area if a second type of user action is detected.

23. The apparatus of claim 22 wherein the user input device includes a mouse that provides the first and second types of user actions, wherein the first type of user action includes a click and drag of the mouse along a first direction, and wherein the second type of user action includes a click and drag of the mouse along a second direction different from the first direction.

24. The apparatus of claim 22 wherein display of the images from one of the series includes a display of spatially related slices organized into that series, and wherein display of the corresponding images from the different series includes display of slices from the different series that are in a same spatial location.

25. The apparatus of claim 22 wherein the storage medium further stores color overlays for at least some of the stored images.

26. The apparatus of claim 22, further comprising a control coupled to the user input device and to the processor to generate interrupts from the first and second types of user actions and to provide the interrupts to the processor.

27. A system, comprising:
a data collection device to generate a plurality of images;
a storage medium coupled to the data collection device to store the plurality of images, the images stored in the storage medium being organized into more than one series of images and having multiple images in at least some of the series;
a display area coupled to the storage medium;
a user input device to provide first and second types of user actions; and
a processor coupled to the user input device and adapted to cooperate with a software program to process the first and second types of user actions provided by the user input device, the processor being adapted to cooperate with the software program to display images from one of the series on the display area if the first type of user action is detected, the processor being adapted to cooperate with the software program to display a corresponding image from a different series on the display area if a second type of user action is detected.

28. The system of claim 27 wherein display of the images from one of the series includes a display of spatially related slices organized into that series, and wherein display of the corresponding images from the different series includes display of slices from the different series that are in a same spatial location.

29. The system of claim 27 wherein the first type of user action includes a drag of the user input device along a first direction, and wherein the second type of user action includes drag of the user input device along a second direction different from the first direction.

30. A user interface, comprising:
a display area to display at least one image from a plurality of images, the images being organized into more than one series of images and having multiple images in at least some of the series; and
a user input device to provide first and second types of user actions, wherein:
the display area is adapted to display images from one of the series, if a first type of user action from the user input device occurs; and
the display area is adapted to display a corresponding image from a different series, if a second type of user action from the user input device occurs.

31. The user interface of claim 30 wherein the user input device includes a mouse that provides the first and second types of user actions, wherein the first type of user action includes a click and drag of the mouse to move a cursor along a first direction on the display area, and wherein the second type of user action includes a click and drag of the mouse to move the cursor along a second direction different from the first direction.

32. The user interface of claim 30 wherein the images include medical images.

33. The user interface of claim 30 wherein display of the images from one of the series by the display area includes a display of spatially related slices organized into that series, and wherein display of the corresponding images from the different series by the display area includes display of slices from the different series that are in a same spatial location.

34. The user interface of claim 33, further comprising slice and series indicators to respectively identify a slice and its corresponding series as the slice is displayed.

35. The user interface of claim 30, further comprising window and level controls to respectively adjust window and level of a displayed image.

36. The user interface of 30, further comprising a color analysis button to identify a portion of interest in a displayed image with color.

37. The user interface of claim 30 wherein the display area is adapted to concurrently display images from the different series on separate display regions, wherein:
the display area is adapted to change, on the display regions, the images from the one of the series, if the first type of user action occurs; and
the display area is adapted to change, on the display regions, the corresponding images from different series, if the second type of user action occurs.

38. The user interface of claim 30 wherein the display area is dynamically scaled to transition from a display of one image to another image within the particular one of the series based on a determined number of images in that series, in a manner that all of the images in that series can be displayed if the first type of user action involves a complete cursor drag between a top end of the display area and a bottom end of the display area, and wherein
the display area is dynamically scaled to transition from a display of one image to another image between different series based on a determined number of series, in a manner that all of corresponding images in the different series can be displayed if the second type of user action involves a complete cursor drag between a left end of the display area and a right end of the display area.

39. The user interface of claim 30 wherein at least one series of images is of a different image type than image types of other series of images.

40. The user interface of claim 30 wherein the display area is adapted to transition to display from one image to another image based on an amount of movement of a cursor controlled by the user input device.
